(19) United States
(12) Patent Application Publication
(10) Pub. No.: US 2007/0241057 A1
(43) Pub. Date: Oct. 18, 2007

(54) Oxo anion-adsorbing ion exchangers

(76) Inventors: Reinhold Klipper, Koln (DE); Wolfgang Podszun, Munchen (DE); Stefan Neumann, Koln (DE); Holger Schafer, Koln (DE); Thomas Linn, Grevenbroich (DE); Wolfgang Zarges, Koln (DE)

Correspondence Address: LANXESS CORPORATION, 111 RIDC PARK WEST DRIVE, PITTSBURGH, PA, 15275-1112, US

(21) Appl. No.: 11/732,933

(22) Filed: Apr. 5, 2007

(30) Foreign Application Priority Data
Apr. 11, 2006 (DE) 10 2006 017 372.4

(51) Int. Cl. B01D 15/00

(52) U.S. Cl. 210/668

(57) ABSTRACT

The present invention relates to a process for the preparation of iron oxide/iron oxyhydroxide-containing weakly basic anion exchangers prepared according to the phthalimide process and their use for removing oxo anions and their thio analogues, preferably of arsenic, from water and aqueous solutions and to a regeneration process.

The present invention relates to a process for the preparation of iron oxide/iron oxyhydroxide-containing weakly basic anion exchangers prepared according to the phthalimide process and their use for removing oxo anions and their thio analogues from water and aqueous solutions.

### BACKGROUND OF THE INVENTION

Oxo anions in the context of the present invention have the formula XₙOₘ⁻, XₙOₘ²⁻, xₙOₘ³⁻, HXₙOₘ⁻ or H₂XₙOₘ²⁻ and their thio analogues in which n is an integer of 1, 2, 3 or 4, m is an integer of 3, 4, 6, 7 or 13, and X is a metal or transition metal from the group of Au, Ag, Cu, Si, P, S, Cr, Ti, Te, Se, V, As, Sb, W, Mo, U, Os, Nb, Bi, Pb, Co, Ni, Fe, Mn, Ru, Re, Tc, Al, B, or a non-metal of the group of F, Cl, Br, I, CN, C, N. Preferably in accordance with the invention, the term oxo anions represents the formulae XOₘ²⁻, XOₘ³⁻, HXOₘ⁻ or H₂XOₘ²⁻ in which m is an integer of 3 or 4 and X is a metal or transition metal from the abovementioned group, is preferably P, S, Cr, Te, Se, V, As, Sb, W, Mo, Bi, or a non-metal from the group of Cl, Br, I, C, N. More preferably in accordance with the invention, the term oxo anions represents oxo anions of arsenic in the (III) and (V) oxidation states, of antimony in the (III) and (V) oxidation states, of sulphur as the sulphate, of phosphorus as the phosphate, of chromium as the chromate, of bismuth as the bismuthate, of molybdenum as the molybdate, of vanadium as the vanadate, of tungsten as the tungstate, of selenium as the selenate, of tellurium as the tellurate or of chlorine as the chlorate or perchlorate. Oxo anions especially preferred in accordance with the invention are H₂AsO₃⁻, H₂AsO₄⁻, HAsO₄²⁻, AsO₄³⁻, H₂SbO₃⁻, H₂SbO₄⁻, HSbO₄²⁻, SbO₄³⁻, SeO₄²⁻, ClO₃⁻, ClO₄⁻, BiO₄²⁻, SO₄²⁻, PO₄³⁻ and their thio analogues. Very particularly preferred in accordance with the invention are the oxo anions H₂AsO₃⁻, H₂AsO₄⁻, HAsO₄²⁻, AsO₄³⁻, and SeO₄²⁻ and also their thio analogues. According to the invention, the term oxo anions also includes the thio analogues in which, in the abovementioned formulae, O is replaced by S.

The requirements on the purity of drinking water have increased significantly in the last few decades. Health authorities in numerous countries have determined limits for heavy metal concentrations in waters. This relates in particular to heavy metals such as arsenic, antimony or chromium.

Under certain conditions, for example, arsenic compounds can be leached out of rocks and hence get into the groundwater. In natural waters, arsenic occurs as an oxidic compound with tri- and pentavalent arsenic. It is found that mainly the species H₃AsO₃, H₂AsO₃⁻, H₂AsO₄⁻, HAsO₄²⁻ occur at the pH values predominating in natural waters.

In addition to the chromium, antimony and selenium compounds, readily absorbable arsenic compounds are highly toxic and carcinogenic. However, bismuth, which gets into the groundwater from ore degradation, is not uncontroversial from a health point of view.

In many regions of the USA, India, Bangladesh, China and in South America, sometimes very high concentrations of arsenic occur in the groundwater.

Numerous medical studies now demonstrate that, in humans which are exposed to high arsenic pollutions over a prolonged period, abnormal skin changes (hyperkeratoses) and various tumour types can develop as a consequence of chronic arsenic poisoning.

On the basis of medical studies, the World Health Organization WHO in 1992 recommended the worldwide introduction of a limit for arsenic in drinking water of 10 μg/l.

In many European countries and in the USA, this value is still being exceeded. Germany has complied with 10 μg/l since 1996; in EU countries, the limiting value of 10 μg/l has applied since 2003, in the USA since 2006.

Ion exchangers are used in a variety of ways to clean untreated waters, wastewaters and aqueous process streams. Ion exchangers are also suitable for removing oxo anions, for example arsenate. Thus, R. Kunin and J. Meyers in Journal of American Chemical Society, Volume 69, page 2874ff. (1947) describe the exchange of anions, for example arsenate, with ion exchangers which have primary, secondary and tertiary amino groups.

The removal of arsenic from drinking water with the aid of ion exchangers is also described in the monograph Ion Exchange at the Millennium, Imperial College Press 2000, page 101ff In this case, strongly basic anion exchangers with different structural parameters, for example resins with trimethylammonium groups, known as the type I resins, based on styrene or acrylate, and resins with dimethylhydroxyethylammonium groups, known as the type II resins, were investigated.

However, a disadvantage of the known anion exchangers is that they do not have the desired and necessary selectivity and capacity for oxo anions, especially toward arsenate ions. Therefore, the uptake capacity for arsenate ions in the presence of the customary anions present in drinking water is only low.

I. Rau et al, Reactive & Functional Polymers 54, (2003) 85-94 describe the removal of arsenate ions by chelating resins having iminodiacetic acid groups which have been occupied by iron(III) ions (chelated). In the preparation thereof, the chelating resin having iminodiacetic acid groups in the acid form is occupied (chelated) by iron(III) ions. The formation of an iron oxide/iron oxyhydroxide phase highly specific for arsenic does not take place in this case, since in the occupation by Fe(III) ions, care is taken not to exceed a pH of 2 (same publication, page 88). Therefore, this adsorber is not able to remove arsenic ions from aqueous solutions down to the legally required residual amounts.

WO 2004/110623 A1 describes a process for preparing an iron oxide/iron oxyhydroxide-containing and carboxyl-containing ion exchanger. This material adsorbs arsenic down to low residual concentrations but has a limited uptake capacity.

U.S. 2005/0156136 discloses a further process for preparing selective adsorbers for the removal of, for example, arsenic. In this process, anion exchangers are brought to reaction with oxidizing agents such as, for example, potassium permanganate and metal salts, such as, for example, iron(II) sulphate. In U.S. 2005/0156136 reference is made to the fact that without the oxidation step, loading the anion exchanger with metal cations does not succeed to the desired extent because of the repulsive forces between anion exchanger matrix and metal cations. A disadvantage of the process according to U.S. 2005/0156136 is, in addition, the fact that ion exchangers are damaged by the reaction with oxidizing agents and in consequence thereof have increased bleeding and a reduced service life.

EP-A 1 568 660 discloses a process for removing arsenic from water by contacting it with a strongly basic anion exchanger which contains a specifically defined metal ion or a metal-containing ion. EP-A 1 568 660 points out that the selectivity toward arsenic rises when secondary and tertiary amino groups are converted to quaternary ammonium groups by alkylation.

EP-A 1 568 660 designates anion exchangers which bear positive charges which are in turn associated with anions such as Cl⁻, Br⁻, F⁻ or OH⁻ as strongly basic anion exchangers.

Quaternary amines are prepared according to EP-A 1 568 660, for example from tertiary amines by addition of an alkyl group. Weakly basic anion exchangers, in contrast, contain primary and/or secondary and/or tertiary amino groups.

The arsenic adsorbers known from the prior art still do not exhibit the desired properties with regard to selectivity and capacity. There is therefore a need for novel bead-form ion exchangers or adsorbers which are specific for arsenic ions, and are simple to prepare and have improved arsenic adsorption.

### DISCLOSURE OF THE INVENTION

The solution to the problem and hence the subject-matter of the present invention is a process for preparing iron oxide/iron oxyhydroxide-containing weakly basic anion exchangers, characterized in that

a) a bead-form weakly basic anion exchanger prepared according to the phthalimide process in aqueous medium is contacted with iron(II) or iron(III) salts and

b) the suspension obtained from a) is adjusted to pH values in the range of 2.5 to 12 by adding alkali metal or alkaline earth metal hydroxides, and the resulting iron oxide/iron oxyhydroxide-comprising ion exchangers are isolated by known methods.

In view of the prior art, it was surprising that these novel iron oxide/iron oxyhydroxide-containing weakly basic anion exchangers can be prepared in a simple reaction and exhibit an oxo anion adsorption which is not only significantly improved over the prior art but is generally also suitable for use for the adsorption of oxo anions, preferably of arsenates, antimonates, phosphates, chromates, molybdates, bismuthates, tungstates, selenites or selenates, particularly preferably of arsenates or antimonates of the (III) and (V) oxidation states or selenites and selenates, from aqueous solutions. This likewise applies to their thio analogues.

The weakly basic anion exchangers to be used in accordance with the invention for the adsorption of oxo anions and their thio analogues may be either heterodisperse or monodisperse. Preference is given in accordance with the invention to using monodisperse weakly basic anion exchangers. Their particle size is generally 250 to 1250 μm, preferably 300-650 μm.

The monodisperse bead polymers which form the basis of the monodisperse weakly basic anion exchangers according to the invention can be prepared by known processes, for example fractionation, jetting or by the seed-feed technique.

The preparation of monodisperse ion exchangers is known in principle to those skilled in the art. A distinction is drawn, aside from the fractionation of heterodisperse ion exchangers by screening, essentially between two direct preparation processes, specifically jetting and the seed-feed process in the preparation of the precursors, the monodisperse bead polymers. In the case of the seed-feed process, a monodisperse feed which can in turn be obtained, for example, by screening or by jetting is used. According to the invention, monodisperse weakly basic anion exchangers obtainable by jetting processes are preferably used for the adsorption of oxo anions.

In the present application, monodisperse refers to those bead polymers or ion exchangers in which the uniformity coefficient of the distribution curve is less than or equal to 1.2. The quotient of the d60 and d10 parameters is referred to as the uniformity coefficient. D60 describes the diameter at which 60% by mass in the distribution curve is smaller and 40% by mass is larger or of equal diameter. D10 refers to the diameter at which 10% by mass in the distribution curve is smaller and 90% by mass is larger or of equal diameter.

The monodisperse bead polymer, the precursor of the ion exchanger, can be prepared, for example, by reacting monodisperse, optionally encapsulated monomer droplets consisting of a monovinylaromatic compound, a polyvinylaromatic compound, and an initiator or initiator mixture and optionally a porogen in aqueous suspension. In order to obtain macroporous bead polymers for the preparation of macroporous ion exchangers, the presence of porogen is absolutely necessary. According to the invention, it is possible to use either gel-form or macroporous monodisperse weakly basic anion exchangers. In a preferred embodiment of the present invention, monodisperse weakly basic anion exchangers manufactured from microencapsulated monomer droplets are used for the preparation of monodisperse bead polymers. The various preparation processes for monodisperse bead polymers, both by the jetting principle and by the seed-feed principle, are known to those skilled in the art from the prior art. At this point, reference is made to U.S. Pat. No. 4,444,961, EP-A 0 046 535, U.S. Pat. No. 4,419,245 and WO 93/12167.

Preferably in accordance with the invention, the monovinylaromatic unsaturated compounds used are compounds such as styrene, vinyltoluene, ethylstyrene, alpha-methylstyrene, chlorostyrene or chloromethylstyrene.

The polyvinylaromatic compounds (crosslinkers) used are divinyl-bearing aliphatic or aromatic compounds. These preferably include divinylbenzene, divinyltoluene, trivinylbenzene, ethylene glycol dimethacrylate, trimethylolpropane trimethacrylate, hexadiene-1,5, octadiene-1,7,2,5-dimethyl-1,5-hexadiene and divinyl ethers.

Suitable divinyl ethers are compounds of the general formula (II) 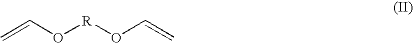
in which

R is a radical from the group of CₙH₂ₙ, (CₘH₂ₘ—O)ₚ—CₘH₂ₘ or CH₂—C₆H₄—CH₂, and n≧2, m=2 to 8 and p≧2.

Suitable polyvinyl ethers in the case that n>2 are trivinyl ethers of glycerol, trimethylolpropane, or tetravinyl ethers of pentaerythritol.

Preference is given to using divinyl ethers of ethylene glycol, di-, tetra- or polyethylene glycol, butanediol or polyTHF, or the corresponding tri- or tetravinyl ethers. Particular preference is given to the divinyl ethers of butanediol and diethylene glycol, as described in EP-A 11 10 608.

The macroporous property desired as an alternative to the gel-form property is given to the ion exchangers as early as in the synthesis of their precursors, the bead polymers. The addition of so-called porogen is absolutely necessary for this purpose. The connection of ion exchangers and their macroporous structure is described in DE-B 1045102 (1957) and in DE-B 1113570 (1957). Suitable porogens for the preparation of macroporous bead polymers to be used in accordance with the invention in order to obtain macroporous anion exchangers are in particular organic substances which dissolve .in the monomer but dissolve and swell the polymer poorly. Examples include aliphatic hydrocarbons such as octane, isooctane, decane, isododecane. Also very suitable are alcohols having 4 to 10 carbon atoms, such as butanol, hexanol or octanol.

In addition to the monodisperse gel-form weakly basic anion exchangers, preference is given in accordance with the invention to using monodisperse weakly basic anion exchangers with macroporous structure for the adsorption of oxo anions. The term “macroporous” is known to those skilled in the art. Details are described, for example, in J. R. Millar et al., J. Chem. Soc. 1963, 218. The macroporous ion exchangers have a pore volume, determined by mercury porosimetry, of 0.1 to 2.2 ml/g, preferably of 0.4 to 1.8 ml/g.

The functionalization of the bead polymers obtainable according to the prior art to give monodisperse, weakly basic anion exchangers is likewise largely known to the person skilled in the art from the prior art. For example, EP-A 1 078 688 describes a process for preparing monodisperse, macroporous, anion exchangers having weakly basic groups by the so-called phthalimide process, by

a) converting monomer droplets composed of at least one monovinylaromatic compound and at least one polyvinylaromatic compound, and also a porogen and an initiator or an initiator combination, to a monodisperse, crosslinked bead polymer,

b) amidomethylating this monodisperse, crosslinked bead polymer with phthalimide derivatives,

c) converting the amidomethylated bead polymer to an aminomethylated bead polymer and

d) allowing the aminomethylated bead polymer to react by partial alkylation to give weakly basic anion exchangers with tertiary amino groups.

According to the invention, for the adsorption of oxo anions and their thio analogues from waters or aqueous solutions use is made of monodisperse, weakly basic, gel-form or macroporous anion exchangers prepared by the phthalimide process, as described, for example, in the abovementioned EP-A 1 078 688. The knowledge obtained in the context of the present invention shows that the monodisperse ion exchangers obtainable according to the phthalimide process according to EP-A 1 078 688 have a degree of substitution of up to approximately 1.8, that is per aromatic nucleus, on a statistical average up to 1.8 hdyrogen atoms are substituted by CH₂NH₂ groups or other weakly basic groups. In particular preferably, according to the invention use is made of monodisperse, macroporous weakly basic anion exchangers prepared by the phthalimide process.

In contrast thereto, the weakly basic anion exchangers described in EP-A 1 568 660 are prepared by the chloromethylation process, crosslinked bead polymers, generally based on styrene/divinylbenzene, are chloromethylated and subsequently reacted with amines (Helfferich, Ionenaustauscher, [ion exchangers], pages 46-58, Verlag Chemie, Weinheim, 1959) and also EP-A 0 481 603. In the reaction of chloromethylated bead polymer with, for example, dimethylamine, the formation of nitrogen bridges proceeds with formation of quaternary amines.

The weakly basic anion exchangers to be used according to the invention for the adsorption of oxo anions and their thio analogues which are prepared by the phthalimide process are uniform in their structure. Surprisingly, it has been found that, in contrast to the post-crosslinking absent in the chloromethylation process, a significantly higher degree of substitution of the aromatic nuclei with functional groups can be achieved, and thus a higher exchange capacity of the weakly basic anion exchanger can be achieved which serves as a basis for the oxo anion exchangers to be used according to the invention. In addition, the work in the context of the present invention demonstrated a significantly higher yield of weakly basic high-capacity anion exchanger based on the monomers used than the weakly basic anion exchangers prepared according to EP-A 1 568 660 by the chloromethylation process.

Consequently, this produces on the basis of high-capacity weakly basic anion exchangers by the phthalimide process, high-capacity iron oxide/iron oxyhydroxide-containing weakly basic anion exchangers which are outstandingly suitable for the adsorption of oxo anions and their thio analogues.

The doping of the weakly basic anion exchanger to give an iron oxide/iron oxyhydroxide-containing ion exchanger according to process step a) is effected with iron(II) salts or iron(III) salts, and in a preferred embodiment with a non-complex-forming iron(II) salt or iron (III) salt. The iron(III) salts used in process step a) of the process according to the invention may be soluble iron(III) salts, preferably iron(III) chloride, iron(III) sulphate or iron(III) nitrate.

The iron(II) salts used may be all soluble iron(II) salts. Preferably, iron(II) chloride, iron(II) sulphate or iron(II) nitrate are used. Preference is given to oxidizing the iron(II) salts to give iron(III) salts in the suspension in process step a) by means of air.

The iron(II) salts or iron(III) salts may be used in bulk or as aqueous solutions.

The concentration of the iron salts in aqueous solution is freely selectable. Preference is given to using solutions having iron salt contents of 20 to 40% by weight.

The timing of the metered addition of the aqueous iron salt solution is uncritical. It can be done as rapidly as possible depending on the technical circumstances.

The weakly basic anion exchangers can be contacted with the iron salt solutions with stirring or by filtration in columns.

1 to 10 mol, preferably 3 to 6 mol, of alkali metal or alkaline earth metal hydroxides are used per mole of iron salt used.

0.1 to 3 mol, preferably 0.3 to 2 mol, of iron salt are used per mole of basic group in the ion exchanger.

The pH in process step b) is adjusted by means of alkali metal or alkaline earth metal hydroxides, especially potassium hydroxide, sodium hydroxide or calcium hydroxide, alkali metal or alkaline earth metal carbonates or hydrogencarbonates.

The pH range within which iron oxide/iron oxyhydroxide groups are formed is in the range between 2 and 12, preferably 3 and 9.

The substances mentioned are preferably used as aqueous solutions.

The concentration of the aqueous alkali metal hydroxide or alkaline earth metal hydroxide solutions may be up to 50% by weight. Preference is given to using aqueous solutions having an alkali metal hydroxide or alkaline earth metal hydroxide concentration in the range of 20 to 40% by weight.

The rate of the metered addition of the aqueous solutions of alkali metal or alkaline earth metal hydroxide depends upon the magnitude of the desired pH and the technical circumstances. For example, 120 minutes are required for this purpose.

On attainment of the desired pH, the mixture is stirred for a further 1 to 10 hours, preferably 2 to 4 hours.

The metered addition of the aqueous solutions of alkali metal or alkaline earth metal hydroxide is effected at temperatures between 10 and 90° C., preferably at 30 to 60° C.

0.5 to 3 ml of deionized water are used per millilitre of ion exchange resin which bear basic groups in order to achieve good stirrability of the resin.

Without proposing a mechanism for the present application, FeOOH compounds which bear freely accessible OH groups on the surface are probably formed in process step b) by virtue of the pH change in the pores of the ion exchange resins. Oxo anions, preferably arsenic, are then probably removed via an exchange of OH⁻ for, for example, HAsO₄²⁻ or H₂AsO₄⁻ to form an AsO—Fe bond.

However, the present invention also relates to weakly basic anion exchangers obtainable by a) contacting a bead-form weakly basic anion exchanger in aqueous medium with iron(II) salts or with iron(III) salts and b) setting the mixture obtained from a) to pHs in the range from 2.5 to 12 by addition of alkali metal hydroxides or alkaline earth metal hydroxides and isolating the resultant iron oxide/iron oxyhydroxide-containing ion exchangers by known methods.

As already described above, ions equally capable of ion exchange are also ions isostructural to HAsO₄²⁻ or H₂AsO₄⁻, for example dihydrogenphosphates, vanadates, molybdates, tungstates, antimonates, bismuthates, selenates or chromates. The weakly basic anion exchangers to be synthesized in accordance with the invention are especially preferably suitable for the adsorption of the species H₂AsO₃⁻, H₂AsO₄⁻, HAsO₄²⁻, AsO₄³⁻, H₂SbO₃⁻, H₂SbO₄⁻, HSbO₄²⁻, SbO₄³⁻, SeO₄²⁻. This also relates to their thio analogues. In particular, very particularly preferably, the iron oxide/iron oxyhydoxide-containing weakly basic anion exchangers to be used according to the invention are suitable for the adsorption of arsenic, preferably in the form of its oxo anions, from water or aqueous solutions.

According to the invention, preference is given to using NaOH or KOH as the base in the synthesis of the iron oxide/iron oxyhydroxide-containing weakly basic anion exchanger. However, it is also possible to use any other base which leads to the formation of FeOH groups, for example NH₄OH, Na₂CO₃, CaO, Mg(OH)₂, etc.

Isolation in the context of the present invention means removal of the ion exchanger from the aqueous suspension and purification thereof The removal is effected by measures known to those skilled in the art, such as decanting, centrifugation, filtration. The purification is effected by washing with, for example, deionized water and may include a classification to remove fines or coarse fractions. The resulting iron oxide/iron oxyhydroxide-containing weakly basic anion exchanger can optionally be dried, preferably by means of reduced pressure and/or more preferably at temperatures between 20° C. and 180° C.

Surprisingly, the inventive iron oxide/iron oxyhydroxide-containing weakly basic anion exchangers adsorb not only oxo anions, for example of arsenic in its wide variety of forms, but also additionally heavy metals, for example cobalt, nickel, lead, zinc, cadmium, copper.

The inventive iron oxide/iron oxyhydroxide-containing weakly basic anion exchangers can be used to purify waters of any type which contain oxo anions, preferably drinking water, wastewater streams of the chemical industry or of refuse incineration plants, and of pit waters or leachate waters of landfill sites.

The inventive iron oxide/iron oxyhydroxide-containing weakly basic anion exchangers are preferably used in apparatus suitable for their tasks.

The invention therefore also relates to apparatus which can be flowed through by a liquid to be treated, preferably filtration units, more preferably adsorption vessels, especially filter adsorption vessels, filled with the iron oxide/iron oxyhydroxide-containing weakly basic anion exchangers obtainable by the process described in this application, for the removal of oxo anions or their thio analogues, preferably arsenic, antimony and selenium, especially of arsenic, from aqueous media, preferably drinking water or gases. The apparatus may be attached to the sanitary and drinking water supply, for example, in the household.

It has been found that the iron oxide/iron oxyhydroxide-containing weakly basic anion exchangers, which are prepared according to the phthalimide process and are to be used in accordance with the invention for the adsorption of oxo anions and their thio analogues, can be regenerated easily by alkaline sodium chloride solutions. The present invention therefore also provides a regeneration process for iron oxide/iron oxyhydroxide-containing weakly basic anion exchangers which are prepared according to the phthalimide process, characterized in that an alkaline sodium chloride solution is allowed to act on them. This sodium chloride solution preferably has a content of sodium chloride of 0.1 to 10% by weight, more preferably of 1 to 3% by weight, and a pH of 6 to 13, preferably of 8 to 11, more preferably of 9 to 10. In a preferred embodiment of the regeneration, the regenerated adsorber is additionally treated with dilute, particularly preferably 1-10% by weight, mineral acids, especially preferably with sulphuric acid or hydrochloric acid.

It will be understood that the specification and examples are illustrative but not limitative of the present invention and that other embodiments within the spirit and scope of the invention will suggest themselves to those skilled in the art.

Analysis Methods

Determination of the Uptake Capacity for Arsenic in the V Oxidation State:

To measure the adsorption of arsenic(V), 250 ml of an aqueous solution of Na₂HAsO₄ with an amount of As(V) of 2800 ppb are adjusted to a pH of 8.5 and agitated with 0.3 ml of arsenic adsorber in a 300 ml polyethylene bottle for 24 hours. After 24 hours, the remaining amount of arsenic(V) in the supernatant solution is analysed.

Determination of the Amount of Basic Aminomethyl Groups in the Amino-Methylated Crosslinked Polystyrene Bead Polymer

100 ml of the aminomethylated bead polymer are compacted by shaking on a tamping volumeter and then flushed into a glass column with demineralized water. Within 1 hour and 40 minutes, 1000 ml of 2% by weight sodium hydroxide solution are filtered through. Subsequently, demineralized water is filtered through until 100 ml of eluate admixed with phenolphthalein have a consumption of 0.1N (0.1 normal) hydrochloric acid of at most 0.05 ml.

50 ml of this resin are admixed in a beaker with 50 ml of demineralized water and 100 ml of 1N hydrochloric acid. The suspension is stirred for 30 minutes and then transferred to a glass column. The liquid is discharged. A further 100 ml of 1N hydrochloric acid are filtered through the resin within 20 minutes. Subsequently, 200 ml of methanol are filtered through. All eluates are collected and combined and titrated with 1N sodium hydroxide solution against methyl orange.

The amount of aminomethyl groups in 1 litre of aminomethylated resin is calculated by the following formula: (200-V)·20=mol of aminomethyl groups per litre of resin, in which V represents volume of the 1N sodium hydroxide solution consumed in the titration.

Determination of the Degree of Substitution of the Aromatic Cores of the Crosslinked Bead Polymer by Aminomethyl Groups

The amount of aminomethyl groups in the total amount of the aminomethylated resin is determined by the above method.

The molar amount of aromatics present in this amount is calculated from the amount of bead polymer used—A in grams—by division by the molecular weight.

For example, 950 ml of aminomethylated bead polymer with an amount of 1.8 mol/l of aminomethyl groups are prepared from 300 grams of bead polymer.

950 ml of aminomethylated bead polymer contain 2.82 mol of aromatics.

1.8/2.81=0.64 mol of aminomethyl groups are then present per aromatic.

The degree of substitution of the aromatic cores of the crosslinked bead polymer by aminomethyl groups is 0.64.

### EXAMPLES

### Example 1

1a) Preparation of a Monodisperse Macroporous Bead Polymer Based on Styrene, Divinylbenzene and Ethylstyrene

A 10 l glass reactor was initially charged with 3000 g of demineralized water, and a solution of 10 g of gelatin, 16 g of disodium hydrogenphosphate dodecahydrate and 0.73 g of resorcinol in 320 g of deionized water were added and mixed. The mixture was adjusted to 25° C. With stirring, a mixture of 3200 g of microencapsulated monomer droplets with narrow particle size distribution, composed of 3.6% by weight of divinylbenzene and 0.9% by weight of ethylstyrene (used in the form of a commercial isomer mixture of divinylbenzene and ethylstyrene with 80% divinylbenzene), 0.5% by weight of dibenzoyl peroxide, 56.2% by weight of styrene and 38.8% by weight of isododecane (technical isomer mixture with high proportion of pentamethylheptane) was then added, the microcapsules consisting of a formaldehyde-hardened complex coacervate of gelatin and a copolymer of acrylamide and acrylic acid, and 3200 g of aqueous phase with a pH of 12 were added. The mean particle size of the monomer droplets was 460 μm.

The mixture was polymerized to completion with stirring by temperature increase according to a temperature programme beginning at 25° C. and ending at 95° C. The mixture was cooled, washed through a 32 μm screen and then dried at 80° C. under reduced pressure. 1893 g of a bead-form polymer with a mean particle size of 440 μm, narrow particle size distribution and smooth surface were obtained.

Viewed from above, the polymer was chalky white and had a bulk density of approx. 370 g/l.

1b) Preparation of an Amidomethylated Bead Polymer

At room temperature, 3567 g of dichloroethane, 867 g of phthalimide and 604 g of 29.8% by weight formalin were initially charged. The pH of the suspension was adjusted to 5.5 to 6 with sodium hydroxide solution. Subsequently, the water was removed by distillation. 63.5 g of sulphuric acid were then metered in. The water formed was removed by distillation. The mixture was cooled. At 30° C., 232 g of 65% oleum and then 403 g of monodisperse bead polymer prepared by process step 1a) were metered in. The suspension was heated to 70° C. and stirred at this temperature for a further 6 hours. The reaction slurry was drawn off, demineralized water was added and residual amounts of dichloroethane were removed by distillation.

Yield of amidomethylated bead polymer: 2600 ml

Elemental analysis composition:

carbon: 74.9% by weight;

hydrogen: 4.6% by weight;

nitrogen: 6.0% by weight;

remainder: oxygen.

1c) Preparation of an Aminomethylated Bead Polymer

624 g of 50% by weight sodium hydroxide solution and 1093 ml of demineralized water were metered at room temperature into 1250 ml of amidomethylated bead polymer from 1b). The suspension was heated to 180° C. within 2 hours and stirred at this temperature for 8 hours. The resulting bead polymer was washed with demineralized water.

Yield of aminomethylated bead polymer: 1110 ml

The total yield—extrapolated—was found to be 2288 ml.

Elemental analysis composition:

nitrogen: 12.6% by weight;

carbon: 78.91% by weight;

hydrogen: 8.5% by weight.

It can be calculated from the elemental analysis composition of the aminomethylated bead polymer that, on average, 1.34 hydrogen atoms per aromatic core—stemming from the styrene and divinylbenzene units—have been substituted by aminomethyl groups.

Determination of the amount of basic groups: 2.41 mol/litre of resin

1d) Preparation of a Bead Polymer With Tertiary Amino Groups

A reactor was initially charged with 1380 ml of demineralized water, 920 ml of aminomethylated bead polymer from 1c) and 490 g of 29.7% by weight formalin solution at room temperature. The suspension was heated to 40° C. The pH of the suspension was adjusted to pH 3 by metering in 85% by weight formic acid. Within 2 hours, the suspension was heated to reflux temperature (97° C.). During this time, the pH was kept at 3.0 by metering in formic acid. On attainment of the reflux temperature, the pH was adjusted to 2 initially by metering in formic acid, then by metering in 50% by weight sulphuric acid. The mixture was stirred at pH 2 for 30 minutes. Further 50% by weight sulphuric acid was then metered in, and the pH was adjusted to 1. At pH 1 and reflux temperature, the mixture was stirred for a further 8.5 hours.

The mixture was cooled, and the resin was filtered off on a sieve and washed with demineralized water.

Volume yield: 1430 ml

In a column, 2500 ml of 4% by weight aqueous sodium hydroxide solution were filtered through the resin. It was then washed with water.

Volume yield: 1010 ml

Elemental analysis composition:

nitrogen: 12.4% by weight;

carbon: 76.2% by weight;

hydrogen: 8.2% by weight;

determination of the amount of basic groups: 2.22 mol/litre of resin

### Example 2

Preparation of an Arsenic Adsorber Based on an Aminomethylated Bead Polymer

271 g of 40% strength by weight aqueous iron(III) sulphate solution were charged into a reactor at room temperature. To this were added 40 ml of demineralized water. Subsequently, with stirring, 300 ml of aminomethylated bead polymer from Example 1c) and thereafter 50 ml of demineralized water were added. The suspension had a pH of 2.3. The pH of the suspension was set to 1.0 using 78% strength by weight sulphuric acid. The solution was stirred for 30 minutes at room temperature.

The pH of the suspension was then set to pH 3.0 in the course of 45 minutes using 50% strength by weight sodium hydroxide solution. The mixture was stirred for a further 60 minutes at pH 3.0. Then, the pH was increased to 3.5 using sodium hydroxide solution and the mixture was stirred for a further 60 minutes at pH 3.5.

Then the pH was increased to 4.0 using sodium hydroxide solution and the mixture was stirred for a further 60 minutes at pH 4.0.

Then the pH was increased to 4.5 using sodium hydroxide solution and the mixture was stirred for a further 60 minutes at pH 4.5.

Then the pH was increased to 5.0 using sodium hydroxide solution and the mixture was stirred for a further 120 minutes at pH 5.0.

During the entire time of adding sodium hydroxide solution, the temperature of the suspension was kept at 20-25° C. by cooling.

The suspension was passed through a sieve, the remaining reaction solution was allowed to run off and the ion exchanger was extracted on the sieve by washing with demineralized water.

Yield: 370 ml

100 ml of moist resin weigh dry 41.96 gram

Iron content: 14:0% by weight

Sodium content: 10 mg/kg of dry resin

### Example 3

Preparation of an Arsenic Adsorber in the Column Process

183 ml of demineralized water, 305 ml of aminomethylated bead polymer from Example 1c) were charged into a glass column (length 50 cm, diameter 12 cm). From the top, in the course of 2 hours, 212 ml of 40% strength by weight aqueous iron(III) sulphate solution were charged. Subsequently, from the bottom, air was passed through the suspension in such a manner that the resin was vortexed. During the entire precipitation and charging operation, vortexing with air was performed. The suspension exhibited a pH of 1.5. With vortexing from the top, 50% strength by weight sodium hydroxide solution was added. The pH of the suspension was set stepwise to 3.0:3.5:4.0:4.5:5.0. After reaching the pH sections, vortexing was further performed in each case for a further 15 minutes. After reaching pH 5.0, the mixture was vortexed for a further 2 hours at this pH. After reaching the pH of 3.5, a further 150 ml of demineralized water were added. Subsequently the resin was passed through a sieve and extracted by washing with demineralized water. Then, for further purification, the resin was washed from the bottom in a glass column for 2 hours using demineralized water and classified.

Consumption of 50% strength by weight sodium hydroxide solution: 75 ml

Volume yield: 350 ml

100 ml of resin weigh dry: 43.80 gram

Iron content: 9.7% by weight

Sodium content: 94 mg/kg of dry resin

### Example 4

Preparation of an Arsenic Adsorber Based on a Bead Polymer Containing Tertiary Amino Groups

421 g of 40% strength by weight aqueous iron(III) sulphate solution were charged into a reactor at room temperature. To this were added 180 ml of demineralized water. Subsequently, with stirring, 500 ml of bead polymer containing tertiary amino groups from Example 1d) were added, and thereafter 50 ml of demineralized water. The suspension has a pH of 2.2. The pH of the suspension was set to 1.0 using 78% strength by weight sulphuric acid. The mixture was stirred for 30 minutes at room temperature. The pH of the suspension was then set to pH 3.0 in the course of 45 minutes using 50% strength by weight sodium hydroxide solution. The mixture was stirred for a further 60 minutes at pH 3.0. Then, the pH was increased to 3.5 using sodium hydroxide solution and the mixture was stirred for a further 60 minutes at pH 3.5. Then, the pH was increased to 4.0 using sodium hydroxide solution and the mixture was stirred for a further 60 minutes at pH 4.0. Then, the pH was increased to 4.5 using sodium hydroxide solution and the mixture was stirred for a further 60 minutes at pH 4.5. Then, the pH was increased to 5.0 using sodium hydroxide solution and the mixture was stirred for a further 120 minutes at pH 5.0. During the entire time of charging sodium hydroxide solution, the temperature of the suspension was kept at 20-25° C. by cooling.

The suspension was passed through a sieve, the remaining reaction solution was allowed to run off and the ion exchanger was extracted by washing on the sieve with demineralized water.

Yield: 780 ml

100 ml of moist resin weigh dry 32.8 gram

Iron content: 11.1% by weight

1. A process for preparing iron oxide/iron oxyhydroxide-containing weakly basic anion exchangers wherein
a) a bead-form weakly basic anion exchanger prepared according to the phthalimide process in aqueous medium is contacted with iron(II) salts or with iron(III) salts and
b) the mixture obtained from a) is adjusted to pH values in the range of 2.5 to 12 by adding alkali metal or alkaline earth metal hydroxides, and the resulting iron oxide/iron oxyhydroxide-containing ion exchangers are isolated by known methods.

2. A process according to claim 1 wherein a monodisperse weakly basic anion exchanger is used in step a).

3. A process according to claim 2 wherein a monodisperse weakly basic anion exchanger is used whose precursor was obtained by the atomization process or jetting.

4. A process according to claim 3 wherein the monodisperse weakly basic anion exchanger has a macroporous structure.

5. A process according to claim 1 wherein the weakly basic anion exchanger contains primary and/or secondary and/or tertiary amino groups.

6. An iron oxide/iron oxyhydroxide-containing weakly basic anion exchanger obtained by a) contacting a bead-form weakly basic anion exchanger prepared according to the phthalimide process in aqueous medium with iron(II) salts or with iron(III) salts and b) adjusting the mixture obtained from a) to pH values in the range from 2.5 to 12 by adding alkali metal or alkaline earth metal hydroxides and isolating the ion exchangers obtained by known methods.

7. A method of using iron oxide/iron oxyhydroxide-containing weakly basic anion exchangers according to claim 6 for adsorbing oxo anions or their thio analogues from water or aqueous solutions.

8. A method of use according to claim 7, wherein oxo anions of the formulae XₙOₘ⁻, XₙOₘ²⁻, XₙOₘ³⁻, HXₙOₘ⁻ or H₂XₙOₘ²⁻ in which n is an integer of 1, 2, 3 or 4, m is an integer of 3, 4, 6, 7 or 13, and X is a metal or transition metal from the group of Au, Ag, Cu, Si, P, S, Cr, Ti, Te, Se, V, As, Sb, W, Mo, U, Os, Nb, Bi, Pb, Co, Ni, Fe, Mn, Ru, Re, Tc, B, Al, or a non-metal of the group of F, Cl, Br, I, CN, C, N are adsorbed.

9. A process for the adsorption of oxo anions from waters or aqueous solutions, from wastewater streams from the chemical industry or from refuse incineration plants, and from pit waters or leachate waters from landfill sites, wherein an iron oxide/iron oxyhydoxide-containing weakly basic anion exchanger according to claim 6 is used.

10. A process according to claim 9, wherein the iron oxide/iron oxyhydroxide-containing weakly basic anion exchanger is used in apparatus that can be flowed through by the liquid to be treated.

11. A regeneration process for iron oxide/iron oxyhydroxide-containing weakly basic anion exchangers prepared according to the phthalimide process, wherein an alkaline sodium chloride solution is allowed to act on them.

12. A regeneration process according to claim 11, wherein additionally the regenerated adsorber is treated with dilute mineral acids.
